(19) United States
(12) Patent Application Publication
(10) Pub. No.: US 2012/0155848 A1
(43) Pub. Date: Jun. 21, 2012

(54) Method and System for Providing Viewfinder Operation in Mobile Device

(75) Inventors: MICHAEL LABOWICZ, Palatine, IL (US); KEVIN FOY, Chicago, IL (US); ANDREW WELLS, Grayslake, IL (US)

(73) Assignee: MOTOROLA-MOBILITY, INC., LIBERTYVILLE, IL (US)

(21) Appl. No.: 12/970,772

(22) Filed: Dec. 16, 2010

(51) Int. Cl. G03B 17/00

(52) U.S. Cl. 396/299

(57) ABSTRACT

In one embodiment, a mobile device system capable of viewfinder operation includes a memory device, a photosensitive device capable of receiving light providing an image of an external object, a video screen, and a processing device coupled at least indirectly to each of the memory and photosensitive devices and the screen, where the processing device provides signal(s) to the screen configured to cause the screen to operate as a viewfinder that displays a further image based upon the external object image. The mobile device further includes at least one sensing device either distinct from or associated with the screen, and configured to detect input commands indicated by movement or positioning of at least one object. The processing device causes the screen to display a plurality of options and subsequently to modify the further image displayed by the viewfinder in accordance with the detected commands. Related operational methods are also described.

### CROSS-REFERENCE TO RELATED APPLICATIONS

### STATEMENT REGARDING FEDERALLY SPONSORED RESEARCH OR DEVELOPMENT

### FIELD OF THE INVENTION

The present invention relates generally to imaging technology and, more particularly, to imaging technology employed in mobile devices and other devices having camera functionality.

### BACKGROUND OF THE INVENTION

Camera functionality has become commonplace in, among things, a variety of mobile devices such as cellular telephones, personal digital assistants (PDAs), smart phones, and other devices. Electronic (particularly digital) processing and storage technologies implemented in such mobile devices make it possible for an operator (e.g., person desiring to take a picture) to rapidly and easily capture, store and review images, among other things, on the operator's mobile device.

Mobile devices (and other devices) having camera-type functionality often include an electronic viewfinder capability. In traditional cameras a viewfinder often was merely a window through which an operator could look to see, directly through the window, an image about to be photographed. Using the window in this manner, the operator could obtain a preview of the image, prior to actually taking a photograph. However, in mobile devices (and other devices) capable of electronic processing and storage of information, a viewfinder is often an electronic display that provides a computer-generated (simulated) image corresponding to the actual image which is in the view of the lens of the mobile device.

Notwithstanding the benefits of current electronic viewfinders in mobile devices, the operation of such viewfinders is not always easy to control. This is particularly of concern as the operations afforded by such viewfinders become more varied and complicated. Therefore, for at least the above reasons, it would be advantageous if an improved method and system for enhancing electronic viewfinder operation in a mobile (or other) device could be developed.

### BRIEF SUMMARY OF THE INVENTION

In at least some embodiments, the present invention relates to a method of providing viewfinder functionality on a mobile device. The method includes providing a mobile device having a processing device, a memory, a photoreceiving device capable of receiving light providing an image of an external object, and a video screen, and detecting a first user input command provided in relation to the mobile device. The method also includes controlling the video screen to operate as a viewfinder so as to display, in addition to a further image identical to or based upon the image of the external object, a first plurality of selectable items in response to the detecting of the first user input command, and detecting a second user input command provided in relation to the mobile device, the second input command being indicative of the user's selection of one of the selectable items. The method additionally includes further controlling the video screen to modify the further image being displayed so as to conform the further image either to the user's selection of the one selectable item or to a setting of a characteristic corresponding to the one selectable item in accordance with a third user input command.

In at least some additional embodiments, the present invention relates to a method of providing viewfinder functionality on a mobile device. The method includes providing a mobile device having a processing device, a memory, a photoreceiving device capable of receiving light providing an image of an external object, and a video screen. The method further includes controlling the video screen to operate as a viewfinder so as to display, in addition to a further image identical to or based upon the image of the external object, a plurality of selectable options in response to the detecting of the first user input command, and detecting a first user input command provided in relation to the video screen, the first user input command being indicative of one of the selectable options selected by the user. Additionally, the method includes further controlling the video screen to display a plurality of selectable suboptions corresponding to the one selectable option selected by the user, and detecting a second user input command provided in relation to the video screen, the second user input command being indicative of one of the selectable suboptions selected by the user. Also, the method includes additionally controlling the video screen to conform the further image either to the user's selection of the one selectable suboption or to a setting of a characteristic corresponding to the one selectable suboption in accordance with a third user input command.

Further, in at least some embodiments, the present invention relates to a mobile device capable of viewfinder operation. The mobile device includes a memory device, a photosensitive device capable of receiving light providing an image of an external object, and a video screen. The mobile device also includes a processing device coupled at least indirectly to each of the memory device, the photosensitive device and the video screen, where the processing device provides one or more signals to the video screen configured to cause the video screen to operate as a viewfinder that displays a further image based upon the image of the external object. The mobile device further includes at least one sensing device either distinct from or associated with the video screen, the at least one sensing device configured to detect user input commands indicated by movement or positioning of at least one user-controlled object. The processing device additionally causes the video screen to first display a plurality of user-selectable options and subsequently to modify the further image displayed by the viewfinder in accordance with the detected user input commands.

### BRIEF DESCRIPTION OF THE DRAWINGS

FIG. 1 is a perspective view of an example mobile device equipped with camera and viewfinder functionality in accordance with an embodiment of the present invention;

FIG. 2 is a block diagram illustrating example components of the mobile device of FIG. 1;

FIG. 3 is a flow chart showing example steps of a method of operating the mobile device of FIGS. 1 and 2 to achieve enhanced viewfinder operation; and

FIGS. 4A-4C are schematic illustrations of example viewfinder operation by the mobile device in accordance with several of the steps of the flow chart of FIG. 3.

### DETAILED DESCRIPTION

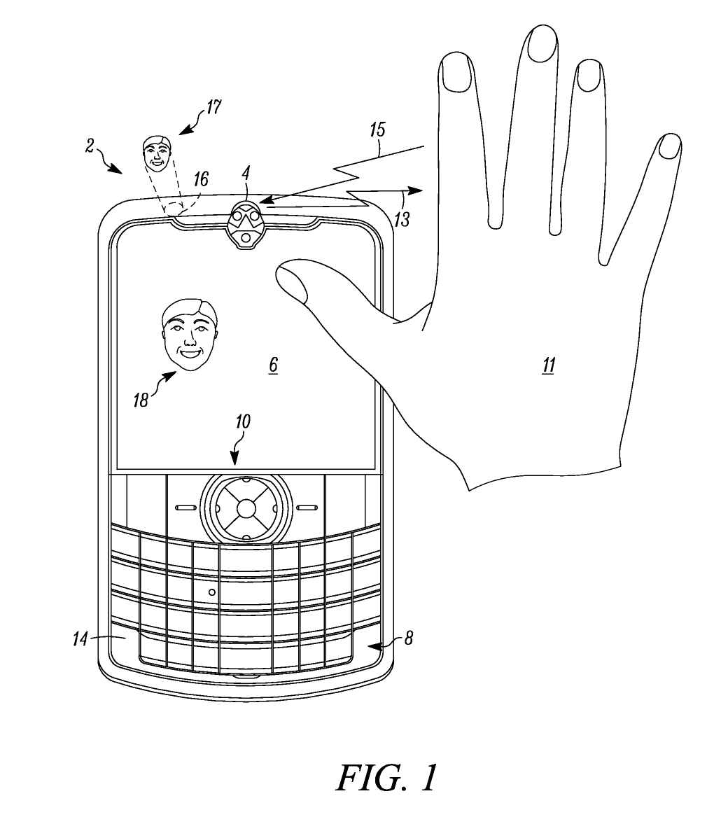

Referring to FIG. 1, an example mobile device 2 is shown that is capable of camera-type functionality including electronic viewfinder functionality as discussed in further detail below. In the present example shown, the mobile device 2 is a personal digital assistant (PDA). Nevertheless, in other embodiments the mobile device can take a variety of other forms. That is, the mobile device of FIG. 1 is also intended to be representative of a variety of other mobile devices that are encompassed within the scope of the present invention including, for example, digital cameras, cellular telephones, smart phones, other handheld or portable electronic devices such as notebook or laptop computing devices, headsets, MP3 players and other portable video and audio players, navigation devices, touch screen input devices, pen-based input devices, battery-powered devices, wearable devices, radios, pagers, PMPs (personal media players), DVRs (digital video recorders), gaming devices, and other mobile devices.

Further included among the components of the mobile device 2 as shown in FIG. 1 are a sensing assembly 4, video screen 6, a keypad 8 having numerous keys, a navigation device (in this case, a “five-way navigation area”) 10, and a camera lens/photosensor 16 capable of receiving light representative of images. As shown, while each of the sensing assembly 4, video screen 6, keypad 8 and navigation device 10 of the mobile device 2 is located along a front surface 14 of the mobile device, the camera lens/photosensor 16 in contrast is located on a rear side of the mobile device, as indicated by the camera lens/photosensor being shown in phantom in FIG. 1. Upon light from an external target such as a target 17 reaching the camera lens/photosensor 16, a signal representative of the external target is generated by the camera lens/photosensor and digitally processed and stored by the mobile device 2. An image 18 representative of the external target 16 (and corresponding to the image of that target received by the camera lens/photosensor 16) can then be displayed on the video screen 6.

In the present embodiment, the video screen 6 and sensing assembly 4 operate in concert with one another to display images and detect user inputs. More particularly, in the present embodiment, the sensing assembly 4 is a pyramid-type sensing assembly that is capable of being used to detect the presence and movements (e.g., gestures) of an object such as (as shown partly in cutaway) a hand 11 of a human being. The sensing assembly 4 not only detects the presence of such an object in terms of whether such object is sufficiently proximate to the sensing assembly (and/or the mobile device), but also detects the object's three-dimensional location relative to the mobile device 2 in three-dimensional space. The sensing assembly can take, for example, any of the forms described in U.S. patent application Ser. No. 12/471,062 filed May 22, 2009, entitled “Sensing Assembly for Mobile Device” and assigned to the beneficial assignee of the present application, the contents of which are hereby incorporated by reference herein.

Further, in the present embodiment, the sensing assembly 4 operates by transmitting one or more (typically multiple) infrared signals 13 out of the sensing assembly, the infrared signals 13 being generated by one or more infrared phototransmitters (e.g., photo-light emitting diodes (photo-LEDs)). The phototransmitters can, but need not, be near-infrared photo-LEDs transmitting light having wavelength(s) in the range of approximately 850 to 890 nanometers. Portions of the infrared signal(s) 13 are then reflected by an object or objects that is/are present such as the hand 11, so as to constitute one or more reflected signals 15. The reflected signals 15 are in turn sensed by one or more infrared light sensing devices or photoreceivers (e.g., photodiodes), which more particularly can (but need not) be suited for receiving near-infrared light having wavelength(s) in the aforementioned range. By virtue of employing either multiple phototransmitters or multiple photoreceivers, the three-dimensional position of the hand 11 relative to the sensing assembly (and thus relative to the mobile device) can be accurately determined.

Notwithstanding the above description of the sensing assembly 4 and video screen 6, the present invention is intended to encompass numerous other arrangements by which images can be displayed to an operator and operator commands as indicated by operator movements (such as by way of the hand 11) can be detected. For example, the video screen 6 can be a capacitive touch screen or resistive touch screen that is both capable of displaying images such as the image 18, and also capable of sensing operator movements across or in relation to the surface of the touch screen. In such case, the video screen can be considered to have a touch-sensitive apparatus integrated with the video display apparatus of the video screen. Also, where a touch screen is employed, the sensing assembly 4 need not be present.

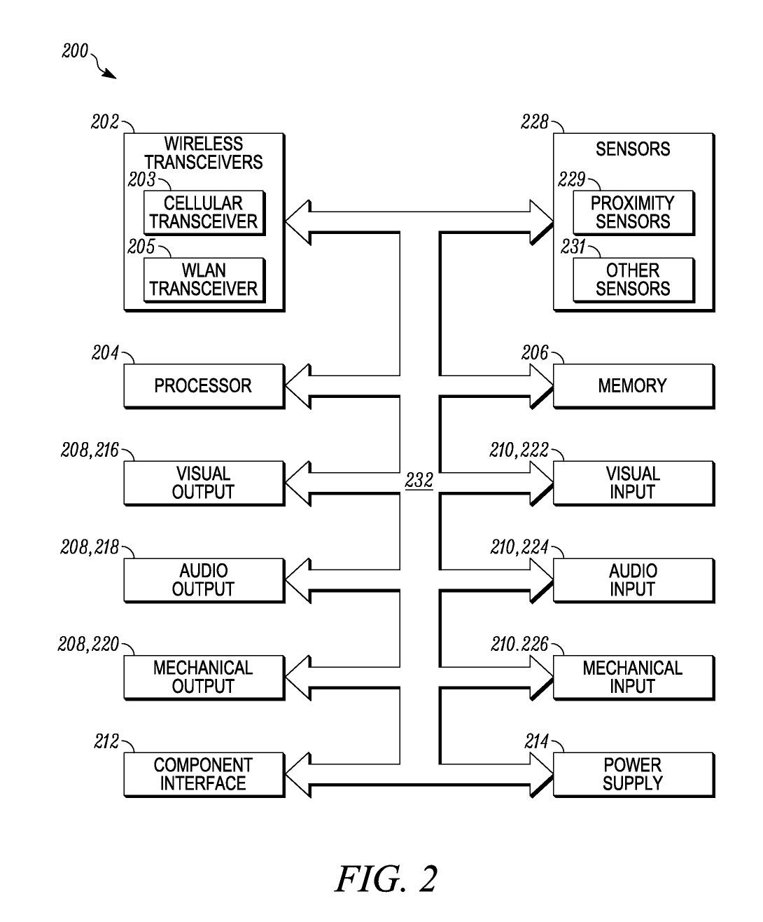

Referring to FIG. 2, there is provided a block diagram illustrating exemplary internal components 200 of a mobile device such as the mobile device 2, in accordance with the present invention. The exemplary embodiment includes wireless transceivers 202, a processor 204 (e.g., a microprocessor, microcomputer, application-specific integrated circuit, etc.), a memory portion 206, one or more output devices 208, and one or more input devices 210. In at least some embodiments, a user interface is present that comprises one or more output devices 208 and one or more input device 210. The internal components 200 can further include a component interface 212 to provide a direct connection to auxiliary components or accessories for additional or enhanced functionality. The internal components 200 preferably also include a power supply 214, such as a battery, for providing power to the other internal components while enabling the mobile device 2 to be portable. As will be described in further detail, the internal components 200 in the present embodiment further include sensors 228 such as the sensing assembly 4 of FIG. 1. All of the internal components 200 can be coupled to one another, and in communication with one another, by way of one or more internal communication links 232 (e.g., an internal bus).

Each of the wireless transceivers 202 utilizes a wireless technology for communication, such as, but not limited to, cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF, Bluetooth and IEEE 802.11 (a, b, g or n), or other wireless communication technologies such as infrared technology. In the present embodiment, the wireless transceivers 202 include both cellular transceivers 203 and a wireless local area network (WLAN) transceiver 205 (which particularly can employ infrared technology), although in other embodiments only one of these types of wireless transceivers (and possibly neither of these types of wireless transceivers, and/or other types of wireless transceivers) is present. Also, the number of wireless transceivers can vary and, in some embodiments, only one wireless transceiver is present and further, depending upon the embodiment, each wireless transceiver 202 can include both a receiver and a transmitter, or only one or the other of those devices.

Exemplary operation of the wireless transceivers 202 in conjunction with others of the internal components 200 of the mobile device 2 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals to a remote device, such as a cell tower or a remote server (not shown).

Depending upon the embodiment, the input and output devices 208, 210 of the internal components 200 can include a variety of visual, audio and/or mechanical outputs. For example, the output device(s) 208 can include a visual output device 216 such as a liquid crystal display and light emitting diode indicator, an audio output device 218 such as a speaker, alarm and/or buzzer, and/or a mechanical output device 220 such as a vibrating mechanism. The visual output devices 216 among other things can include the video screen 6 of FIG. 1. Likewise, by example, the input devices 210 can include a visual input device 222 such as an optical sensor (for example, the camera lens/photosensor 16 of FIG. 1), an audio input device 224 such as a microphone, and a mechanical input device 226 such as a flip sensor, keyboard, keypad, selection button, touch pad, touch screen, capacitive sensor, motion sensor, and switch. The mechanical input device 226 can in particular include, among other things, the keypad 8 and the navigation device 10 of FIG. 1. Actions that can actuate one or more input devices 210 can include, but need not be limited to, opening the mobile device, unlocking the device, moving the device to actuate a motion, moving the device to actuate a location positioning system, and operating the device.

Although the sensors 228 of the internal components 200 can in at least some circumstances be considered as being encompassed within input devices 210, given the particular significance of one or more of these sensors 228 to the present embodiment the sensors instead are described independently of the input devices 210. In particular as shown, the sensors 228 can include both proximity sensors 229 and other sensors 231. The proximity sensors 229 in turn can include, among other things, the sensing assembly 4 of FIG. 1 by which the mobile device 2 is able to detect the presence of (e.g., the fact that the mobile device is in sufficient proximity to) and location of one or more external objects including portions of the body of a human being such as the hand 11 of FIG. 1. By comparison, the other sensors 231 can include other types of sensors, such as a location circuit 228 that can include, for example, a Global Positioning System (GPS) receiver, a triangulation receiver, an accelerometer, a gyroscope, or any other information collecting device that can identify a current location of the mobile device 2.

Notwithstanding the above description, in other embodiments where a capacitive or resistive touch screen is employed as the video screen 6 for the purpose of both displaying images and receiving user inputs (instead of the sensing assembly 4 and video screen 6), the touch screen can be considered to be one of the visual output devices 216 as well as one of the mechanical input devices 226.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. The data that is stored by the memory portion 206 can include, but need not be limited to, operating systems, applications, and informational data. Each operating system includes executable code that controls basic functions of the communication device, such as interaction among the various components included among the internal components 200, communication with external devices via the wireless transceivers 202 and/or the component interface 212, and storage and retrieval of applications and data to and from the memory portion 206. Each application includes executable code that utilizes an operating system to provide more specific functionality for the communication devices, such as file system service and handling of protected and unprotected data stored in the memory portion 206.

As for the informational data, that data is non-executable code or information that can be referenced and/or manipulated by an operating system or application for performing functions of the communication device. Such data can include, for example, image data representative of images such as the image 17 obtained by the camera lens/photosensor 16.

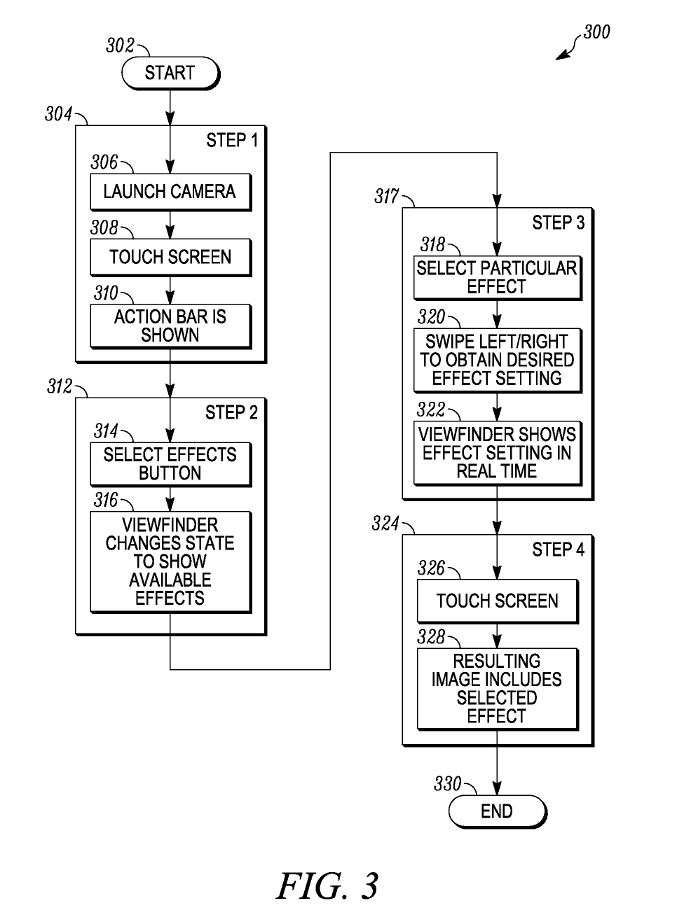

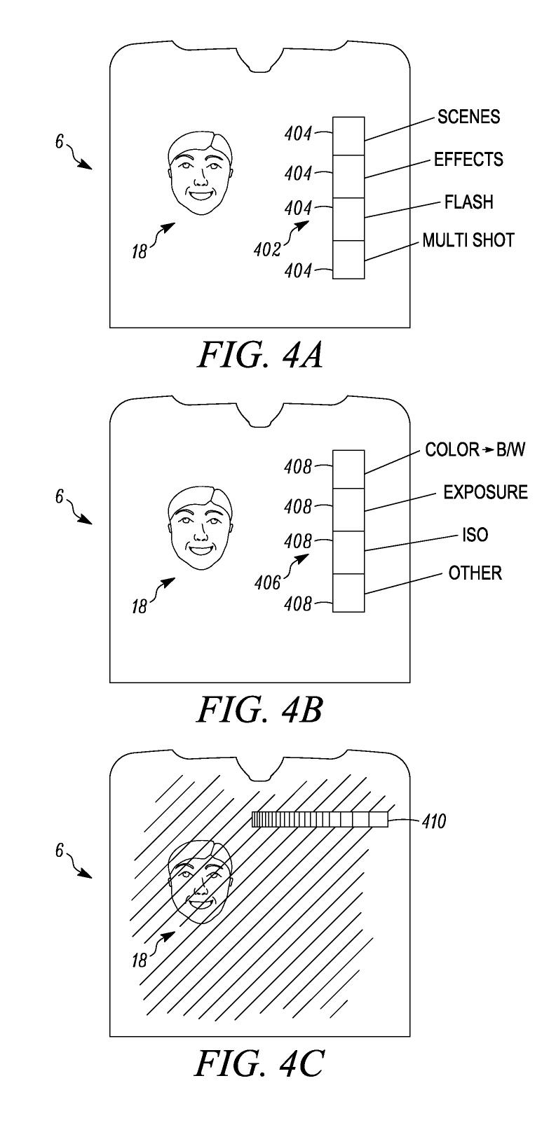

Turning to FIG. 3, a flow chart 300 is provided that shows example steps of the mobile device 2 in effecting operation of an electronic viewfinder as part of camera functionality provided by the mobile device. As will be discussed further below, FIGS. 1 and 4A-4C also provide schematic illustrations of the video screen 6 operating as an electronic viewfinder at different points in the process represented by the flow chart 300. Operating in the manner described, the viewfinder enhances the camera-related functionality of the mobile device in terms of, among other things, facilitating adjustments in the manner of viewfinder display by way of user inputs (e.g., gesture inputs), and affording real-time preview capabilities.

As shown in FIG. 3, upon commencing at a start step 302, the process represented by the flow chart 300 begins with a first group of steps 304 including first, second and third substeps 306, 308 and 310. The first substep 306 involves launching of the camera function of the mobile device, which can be accomplished when an operator/user selects camera functionality from among a variety of possible functions available on the mobile device 2 as represented on a menu (not shown) displayed by the video screen 6. As with other user inputs, such a user selection can be sensed by sensing assembly 4 or, in other embodiments where the video screen 6 is a touch screen, can be sensed by the video screen itself, based upon movements or positioning of the hand 11 (where the touch screen is used, this would typically involved touching of the hand to the screen).

Once the camera function has been launched at the substep 306, the video screen 6 then automatically enters a viewfinder mode of operation such that, as shown in FIG. 1, the video screen displays the image 18 corresponding to the target 17 that is within view of the camera lens/photosensor 16. That is, FIG. 1 shows the mobile device 2 to be operating in a standard viewfinder mode of operation upon the launching of the camera function of the mobile device. Once the mobile device 2 is operating in this manner, the mobile device then awaits a further user instruction. In particular, such instruction can be provided at the substep 308 when the user touches the video screen 6, again by way of the hand 11, as sensed by way of the sensing assembly 4. Upon the touching of the video screen 6 at the substep 308, then an action bar is shown on the video screen 6, at the substep 310.

Referring additionally to FIG. 4A in this regard, the video screen 6 no longer shows merely the image 18 as shown in FIG. 1, but rather is shown to be updated to include an action bar 402. As further illustrated in FIG. 4A, the action bar 402 in the present embodiment is a strip including several (in this example, four) option buttons 404, which in this case include a scenes button, an effects button, a flash button, and a multishot button. Generally speaking, the action bar 402 sets forth various types/categories of actions that the user can select from in terms of causing a modification in viewfinder (or camera) operation. Upon one of the option buttons 404 of the action bar 402 being selected by a user (again for example when the user touches the respective button with the hand 11), a type of action corresponding to that button is taken by the mobile device 2 in terms of identifying options that can be implemented in regards to further viewfinder operation.

Returning to FIG. 3, upon the completion of the substep 310, the first group of steps 304 is completed and the process advances to a second group of steps 312 encompassing first and second substeps 314 and 316, respectively. At the first substep 314, the user further selects from the action bar one of the option buttons 404. In the present example, it is particularly assumed that it is the effects button that is selected, albeit in other embodiments the other ones of the option buttons 404 can alternatively be selected. As already mentioned, the effects button can be selected by the user when the hand 11 touches a portion of the video screen 6 displaying that button of the action bar 402. Upon receiving the user input specifying selection of the effects button, the viewfinder functionality changes state such that the video screen 6 no longer displays the action bar 402. Rather, at this time, the video screen 6 instead displays (in addition to the image 18 corresponding to the target 17 within the view of the camera lens/photo sensor 16) an effects bar 406 having additional option buttons 408 concerning various available viewfinder effects that can be selected and applied, as shown in FIG. 4B.

The additional option buttons 408 can be considered to allow selection of suboptions corresponding to the effects option button already selected at the substep 314. Although not shown in detail, it should be understood that, in the present embodiment, each of the other actions corresponding to the other ones of the option buttons 404 similarly have associated therewith one or more suboptions that are selectable by the user in the event those respective option buttons are selected by the user. Alternatively, in some other embodiments, while one or more of the action items corresponding to the option buttons 404 have corresponding selectable suboptions, other one(s) of the actions do not.

More particularly, in the present embodiment as shown in FIG. 4B, the additional options buttons 408 provided by the effects bar 406 include a color to black and white (color to B/W) option button, an exposure (or shutter speed) selection button, an ISO (film speed) button, and an “other” button. It should be noted that, in other embodiments, or other circumstances, one or more other buttons (e.g., an aperture selection button) can be present in addition to or instead of the particular additional options buttons 408 shown in FIG. 4B. For example, the presence of the color to B/W option button appears when the video screen 6 is currently operating as a color viewfinder, such that the video screen is displaying the image 18 in color (as is presumed to be the case for FIG. 4B). However, if the image 18 was currently displayed in black and white, then a different additional option button for changing black and white to color would instead appear.

Next, upon the video screen 6 viewfinder showing the effects bar 406 with the additional options buttons 408 corresponding to available effects, the process advances to a third step grouping 317 that particularly includes first, second, and third substeps 318, 320 and 322, respectively. At the first substep 318, similar to the first substep 314, the user further selects from the effects bar 406 one of the additional option buttons 408. In the present example, it is particularly assumed that it is the color to B/W additional option button that is selected, albeit in other embodiments the other ones of the additional option buttons 404 can alternatively be selected. As mentioned earlier, the color to B/W additional options button (or any of the other additional option buttons 404) can be selected by the user when the hand 11 touches a portion of the video screen 6 displaying that button of the effects bar 404.

Often, if not universally, a selected effect as specified at the substep 318 is an effect that in turn can be provided at a variety of settings. For example, the degree to which an image such as the image 18 is shown in color versus black and white can vary along a continuum having more or less vivid colors. Likewise, the degree of exposure can be varied along a continuum, as can the film speed. Thus, the selection of a particular effect at the substep 318 does not necessarily fully specify a user selection. Rather, in such cases and particularly in the present embodiment shown in FIGS. 3-4, the user upon selecting an effect at the substep 318 is then further provided, at the substep 320, with an opportunity to further specify a setting of the effect. More particularly, in the present embodiment, the video screen 6 at the second substep 320 displays a corresponding effect setting bar and the user then swipes the hand 11 leftward or rightward along the video screen 6 (and particularly the effect setting bar). By providing that motion/gesture, a desired effect setting or level is specified and consequently the video screen 6 viewfinder operation shows the effect setting to be implemented in real time, in the third substep 322, by applying the effect setting immediately to the image displayed by the viewfinder.

For example, as further shown in FIG. 4C, assuming that the additional option button 406 selected in the first substep 318 concerns the exposure, then an exposure effect setting bar 410 is displayed on the video screen 6 as part of the viewfinder operation. Further assuming that the hand 11 is sensed by the mobile device 102 as moving leftward, a darker exposure setting is selected and correspondingly the image 18 displayed by the video screen 6 viewfinder becomes darker (as represented by the diagonal hash lines shown as extending across the video screen).

Although in this example, the hand 11 is swiped leftward (or rightward) to select an effect setting, in other embodiments other motions or actions can specify a selection. For example, the hand 11 instead can be moved toward or away from the video screen 6, upward or downward (perpendicular to the leftward/rightward movement mentioned above) along the video screen, or moved so as to touch a particular portion of the video screen 6. This can particularly be the case if an effect setting bar is oriented in a different (e.g., vertical rather than horizontal as shown in FIG. 4C) orientation, or if other input icon(s) (e.g., multiple selectable buttons) are provided by which a user can specify an effect setting.

Finally, the process advances to a fourth step grouping 324, which includes first and second substeps 326 and 328, respectively, after which the process ends at an end step 330. During the fourth step grouping 324, the user confirms the previous setting that was specified at the substep 320 and displayed tentatively in the substep 322, such that ongoing operation of the viewfinder and camera functionality is in accordance with that setting. More particularly, in the present embodiment at the first substep 326, the user touches the video screen 6 to confirm the previous setting specified at the substep 320. By touching the video screen 6, the user therefore specifies that the selected effect setting should be applied to any image that is then captured and recorded (permanently or semi-permanently) by the mobile device 2. Although touching of the video screen 6 is interpreted as the confirmation signal in this embodiment, it should be recognized that in other embodiments other movements of the hand 11 can also be considered by the mobile device 2 as indicative of a user confirmation of an effect setting.

Once the video screen 6 has been touched at the first substep 326, then at the second substep 328 the image 18, shown by the video screen acting as the viewfinder, continues to be displayed in a manner consistent with the chosen effect setting. Further, in the event an additional user input is received indicating a user command that an image/photograph/snapshot or video be taken, then the effect setting already displayed by the viewfinder is further applied to the taking of the image/photograph/snapshot or video. Although not shown, multiple images/photographs/snapshots and/or videos can be taken that are consistent with the chosen effect setting.

Although the process is shown to end in FIG. 3 at the end step 330, it should be understood that the process represented by the flow chart 300 can be performed repeatedly such that multiple different actions, effects, and effect settings are selected (or modified) and implemented. That is, the previously-described example of an action, effect and effect setting that are selected by a user with respect to the operation of the viewfinder is only one example, and numerous other actions, effects and effect settings can be selected by a user. Not only can several of the different actions be taken (e.g. actions to change effects as well as actions to changes scenes), but also each of the different effects (color to B/W, exposure, ISO, other) can be selected and set to different settings that each apply to the viewfinder.

Further, notwithstanding the action bars 402, 406 and associated option buttons 404 and 408 and setting bars shown in FIGS. 4A-4C, in other embodiments other options than those shown can be made available to a user. Among other things, the particular effects that are available on any given mobile device can vary with the mobile device or the application. Also, while the above-described manner of operation is such that, to completely perform an action, it is envisioned that a user will provide not only an action bar input (e.g., the selection of the effects option) but also a subsequent selection input (e.g., the selection of an effect of interest) as well as a subsequent setting input (e.g., setting the exposure level), this need not be the case in all embodiments or with respect to all selected actions. Rather, some actions in some circumstances or embodiments instead will be able to specified by a user simply based upon a single subsequent input by the user.

For example, in one alternate embodiment, upon a user input selecting the effects option from the action bar, an effects listing will appear that will specifically list all possible effects from which an option can be selected by a user, and consequently no user input setting a level is required (that is, there is no need for a step corresponding to FIG. 4A). Alternatively, in another alternate embodiment, multiple setting bars are immediately displayed upon the choice of one of the action options from the action bar, and the user can therefore specify a particular setting of interest immediately without choosing any option from an effects bar (that is, there is no need for a step corresponding to FIG. 4B).

It is specifically intended that the present invention not be limited to the embodiments and illustrations contained herein, but include modified forms of those embodiments including portions of the embodiments and combinations of elements of different embodiments as come within the scope of the following claims.

1. A method of providing viewfinder functionality on a mobile device, the method comprising:
providing a mobile device having a processing device, a memory, a photoreceiving device capable of receiving light providing an image of an external object, and a video screen;
detecting a first user input command provided in relation to the mobile device;
controlling the video screen to operate as a viewfinder so as to display, in addition to a further image identical to or based upon the image of the external object, a first plurality of selectable items in response to the detecting of the first user input command;
detecting a second user input command provided in relation to the mobile device, the second input command being indicative of the user's selection of one of the selectable items; and
further controlling the video screen to modify the further image being displayed so as to conform the further image either to the user's selection of the one selectable item or to a setting of a characteristic corresponding to the one selectable item in accordance with a third user input command.

2. The method of claim 1, wherein the second user input command is detected by sensing either a touching of the video screen or a user gesture in relation to the mobile device.

3. The method of claim 2, wherein the sensing is achieved either by way of a proximity sensing assembly of the mobile device or by way of a touch-sensing apparatus associated with the video screen.

4. The method of claim 1, further comprising detecting a fourth user input command provided in relation to the mobile device prior to the first user input command, in response to which the mobile device begins to operate in a viewfinder mode so as to display the further image identical to or based upon the image of the external object.

5. The method of claim 1, wherein the first plurality of selectable items includes a plurality of action items including two or more of a scenes action item, an effects action item, a flash action item, and a multishot action item.

6. The method of claim 1, wherein the first plurality of selectable items includes a plurality of effects items including two or more of a color to black and white effect item, a black and white to color effect item, an exposure effect item, an ISO effect item, and an other effect item.

7. The method of claim 6, wherein the one selectable item is the exposure effect item, wherein the characteristic is an exposure characteristic, wherein the third user input command is indicative of the setting of the exposure characteristic, and wherein the further controlling of the video screen conforms the further image to the setting of the exposure characteristic.

8. The method of claim 7, further comprising detecting a fourth user input command subsequent to the further controlling, wherein the fourth user input command is representative of a user confirmation that the setting of the exposure characteristic should be implemented in an ongoing manner with respect to continued operation of the video screen as the viewfinder.

9. The method of claim 8, wherein as a result of the fourth user input command, the setting of the exposure characteristic is applied to at least one of an image and a video captured by the mobile device.

10. The method of claim 1, wherein the mobile device is selected from the group consisting of a cellular telephone, a personal digital assistant (PDA), and a digital camera.

11. A method of providing viewfinder functionality on a mobile device, the method comprising:
providing a mobile device having a processing device, a memory, a photoreceiving device capable of receiving light providing an image of an external object, and a video screen;
controlling the video screen to operate as a viewfinder so as to display, in addition to a further image identical to or based upon the image of the external object, a plurality of selectable options in response to the detecting of the first user input command;
detecting a first user input command provided in relation to the video screen, the first user input command being indicative of one of the selectable options selected by the user;
further controlling the video screen to display a plurality of selectable suboptions corresponding to the one selectable option selected by the user;
detecting a second user input command provided in relation to the video screen, the second user input command being indicative of one of the selectable suboptions selected by the user;
additionally controlling the video screen to conform the further image either to the user's selection of the one selectable suboption or to a setting of a characteristic corresponding to the one selectable suboption in accordance with a third user input command.

12. The method of claim 11, wherein the selectable options include two or more of a scenes option, an effects option, a flash option, and a multishot option.

13. The method of claim 12, wherein the one selectable option is the effects operation, and wherein the selectable suboptions include two or more of a color to black and white effect suboption, a black and white to color effect suboption, an exposure effect suboption, an ISO effect suboption, and an other effect suboption.

14. The method of claim 11 wherein, prior to the detecting of the first user input command, an initial user input command is detected, in response to which the video screen begins to operate as the viewfinder.

15. The method of claim 11, further comprising detecting the third user input command by detecting a movement of a user hand across the video screen, the detected third user input command specifying the setting of an exposure level that is the characteristic.

16. The method of claim 11, wherein the mobile device is selected from the group consisting of a cellular telephone, a personal digital assistant (PDA), and a digital camera.

17. A mobile device capable of viewfinder operation, the mobile device comprising:
a memory device;
a photosensitive device capable of receiving light providing an image of an external object;
a video screen;
a processing device coupled at least indirectly to each of the memory device, the photosensitive device and the video screen, wherein the processing device provides one or more signals to the video screen configured to cause the video screen to operate as a viewfinder that displays a further image based upon the image of the external object; and
at least one sensing device either distinct from or associated with the video screen, the at least one sensing device configured to detect user input commands indicated by movement or positioning of at least one user-controlled object,
wherein the processing device additionally causes the video screen to first display a plurality of user-selectable options and subsequently to modify the further image displayed by the viewfinder in accordance with the detected user input commands.

18. The mobile device of claim 17, wherein the plurality of user-selectable options includes a first set of action options including an effects option, and a second set of effects suboptions including one or more of color display-related suboption, an exposure-related suboption, a shutter-speed suboption, and an other suboption.

19. The mobile device of claim 17, wherein at least one of the detected user input commands relates to a setting of a characteristic capable of being set to a variety of levels along a continuum.

20. The mobile device of claim 17, wherein the at least one sensing device includes at least one of a proximity sensing device distinct from the video screen and a touch screen apparatus integrated as part of the video screen, and wherein the mobile device is one of a cellular telephone, a personal digital assistant (PDA), and a digital camera.
